(19) United States
(12) Patent Application Publication
(10) Pub. No.: US 2022/0152765 A1
(43) Pub. Date: May 19, 2022

(54) MACHINE TOOL WITH A THERMAL COMPENSATION EFFECT

(71) Applicant: AWEA MECHANTRONIC CO., LTD., HSINCHU (TW)

(72) Inventors: SHIH-SYUE SHIH, HSINCHU (TW); YUAN-YI CHU, HSINCHU (TW); CHIUAN-FENG YAU, HSINCHU (TW)

(21) Appl. No.: 16/951,277

(22) Filed: Nov. 18, 2020

(51) Int. Cl. B23Q 11/00

(52) U.S. Cl. CPC B23Q 11/0003

(57) ABSTRACT

A tool has a machine body, a driving assembly, and a machining assembly. The driving assembly has a first holding base, a second holding base, a threaded rod, a moving base, and a thermal compensation gap. The threaded rod is formed as a single part and has a driving thread segment, a first assembling segment, and a second assembling segment. The driving thread segment has a first end and a second end opposite the first end. The thermal compensation gap is formed between the first end of the driving thread segment and the first holding base. The machining assembly is mounted securely on the moving base.

### BACKGROUND OF THE INVENTION

### 1. Field of the Invention

The present invention relates to a machine tool, and more particularly to a machine tool with a thermal compensation effect to improve the machining accuracy of the machine tool.

### 2. Description of Related Art

With reference to FIG. 6, a conventional machine tool 80 is applied for lathe-turning, milling, or drilling a hole in a workpiece and substantially comprises a machine body 81, a column 82, a platform 83, a driving assembly 84, and a machining assembly 85. The column 82 is mounted on the machine body 81 and has a top end away from the machine body 81. The platform 83 is mounted on the machine body 81. The driving assembly 84 is connected with the column 82 and comprises a first holding base 841, a second holding base 842, a threaded rod 843, and a moving base 844. The first holding base 841 and the second holding base 842 are mounted securely on the column 82 and are spaced from each other. The first holding base 841 is located at a position being adjacent to the top of the column 82, and the second holding base 842 is located at a position being adjacent to the platform 83. The threaded rod 843 is mounted rotatably between the first holding base 841 and the second holding base 842 and comprises a driving thread segment 8431. The driving thread segment 8431 has a first end 84311 and a second end 84312 opposite each other. The first end 84311 of the driving thread segment 8431 is adjacent to the first holding base 841, and the second end 84312 of the driving thread segment 8431 is adjacent to the second holding base 842.

With reference to FIGS. 7 and 8, the first end 84311 of the driving thread segment 8431 abuts against the first holding base 841 that is adjacent to the top end of the column 82. A thermal compensation gap d is formed between the second end 84312 of the driving thread segment 8431 and the second holding base 842. The moving base 844 is mounted around and screwed with the driving thread segment 8431 and is reciprocally moveable along the driving thread segment 8431. The machining assembly 85 is mounted on the moving base 844, is moveable toward or away from the platform 83, and comprises an axle 851 and a tool 852.

Because heat will be generated due to the friction between the moving base 844 and the threaded rod 843 while the moving base 844 is moved along the threaded rod 843, the thermal compensation gap d is formed between the second end 84312 of the driving thread segment 8431 and the second holding base 842 to provide a margin for the thermal compensation of the threaded rod 843. However, heat will also be generated on the axle 851 of the machining assembly 85 and the axle 851 expands toward a direction where the axle 851 is not limited. That is, a thermal expansion will be generated toward the platform 83.

In addition, the thermal compensation gap d formed between the second end 84312 of the driving thread segment 8431 and the second holding base 842 is located at a position adjacent to platform 83. Thus, when the driving assembly 84 and the axle 851 both have thermal expansions toward the platform 83, the working depth applied onto the workpiece held on the platform 83 will be increased. Therefore, the machining accuracy of the conventional machine tool 80 is not precise.

To overcome the shortcomings, the present invention tends to provide a machine tool to mitigate or obviate the aforementioned problems.

### SUMMARY OF THE INVENTION

The main objective of the invention is to provide a machine tool that is precise in machining accuracy.

The machine tool in accordance with the present invention has a machine body, a driving assembly, and a machining assembly. The machine body has a workpiece mount. The driving assembly has a first holding base, a second holding base, a threaded rod, a moving base, and a thermal compensation gap. The first holding base and the second holding base are mounted securely on the machine body and are spaced from each other. The threaded rod is formed as a single part and has a driving thread segment, a first assembling segment, and a second assembling segment. The driving thread segment has a first end and a second end opposite the first end. The first assembling segment is co-axially formed on and protrudes from the first end of the driving thread segment and is connected rotatably with the first holding base. The second assembling segment is co-axially formed on and protrudes from the second end of the driving thread segment, extends toward the workpiece mount, and is connected rotatably with the second holding base. The moving base is mounted around and screwed with the driving thread segment and is reciprocally moveable along the driving thread segment. The thermal compensation gap is formed between the first end of the driving thread segment and the first holding base. The machining assembly is mounted securely on the moving base.

Other objects, advantages and novel features of the invention will become more apparent from the following detailed description when taken in conjunction with the accompanying drawings.

### BRIEF DESCRIPTION OF THE DRAWINGS

FIG. 1 is a perspective view in partial section of a machine tool in accordance with the present invention;

FIG. 2 is an enlarged side view in partial section of the machine tool in FIG. 1;

FIG. 3A is an enlarged side view in partial section of an embodiment of an arrangement of thrust bearings of the machine tool in FIG. 1;

FIG. 3B is an enlarged side view in partial section of another embodiment of an arrangement of thrust bearings of the machine tool in FIG. 1;

FIG. 4 is an operational perspective view in partial section of the machine tool in FIG. 1;

FIG. 5 is an enlarged side view in partial section of the machine tool in FIG. 4;

FIG. 6 is a perspective view in partial section of a machine tool in accordance with the prior art;

FIG. 7 is an enlarged side view in partial section of the machine tool in FIG. 6; and

FIG. 8 is another enlarged side view in partial section of the machine tool in FIG. 6.

### DETAILED DESCRIPTION OF PREFERRED EMBODIMENT

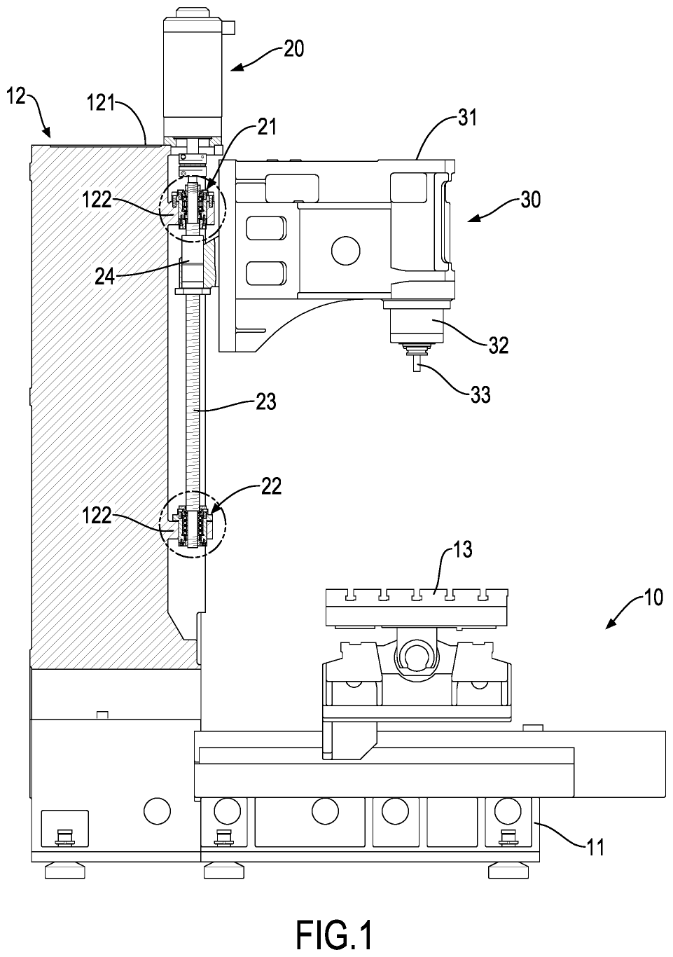

With reference to FIG. 1, a machine tool in accordance with the present invention comprises a machine body 10, a driving assembly 20, and a machining assembly 30. The driving assembly 20 is mounted on the machine body 10, and the machining assembly 30 is mounted on the driving assembly 20.

With reference to FIG. 1, the machine body 10 comprises a machine base 11, a column 12, and a workpiece mount 13. The machine base 11 is laterally arranged. The column 12 is uprightly mounted on the machine base 11 and has a top end 121 away from the machine base 11 and two saddle bases 122. The two saddle bases 122 are spaced from each other. One of the saddle bases 122 is located at a position adjacent to the top end 121 of the column 12, and the other one of the two saddle bases 122 is located as a position adjacent to the machine base 11. The workpiece mount 13 is mounted on the machine base 11 to hold a workpiece in place. Preferably, the workpiece mount 13 is a platform, or the workpiece mount 13 may be a fixture assembly such as a clamping chuck.

With reference to FIGS. 1, 2, 3A, and 3B, the driving assembly 20 comprises a first holding base 21, a second holding base 22, a threaded rod 23, a moving base 24, a spacing collar 25, and a thermal compensation gap D. The first holding base 21 is mounted on one of the saddle bases 122 which is adjacent to the top end 121 of the column 12. The first holding base 21 comprises a base body 211, an oil seal, and two thrust bearings 212. The oil seal and the two thrust bearings 212 are mounted in the base body 211. The holding bases 21, 22 for connecting with the threaded rod 23 may be conventional, so the detailed structures of the holding bases 21, 22 are omitted from the description.

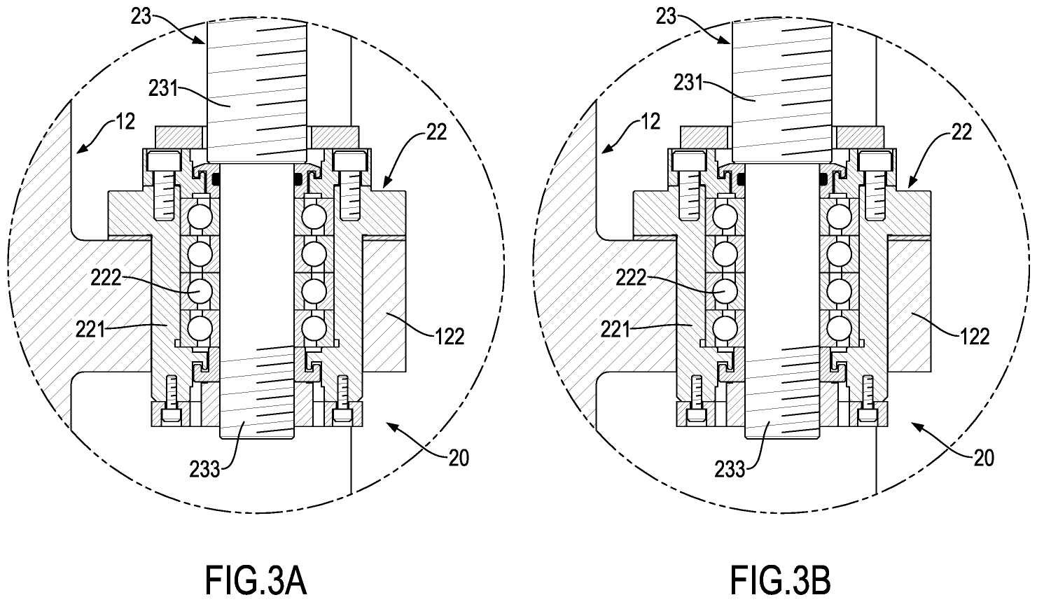

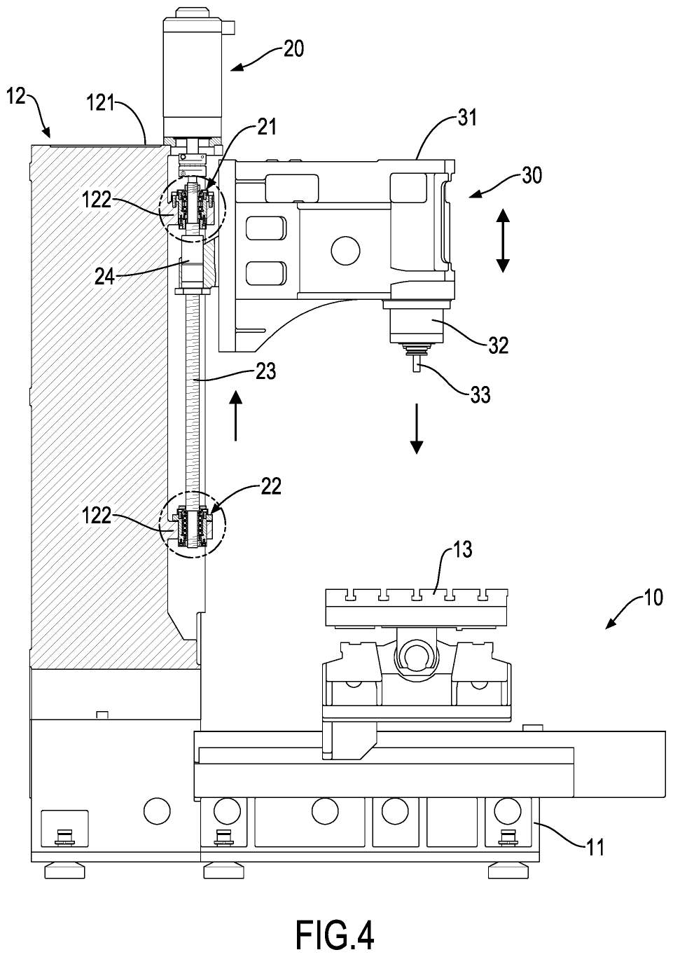

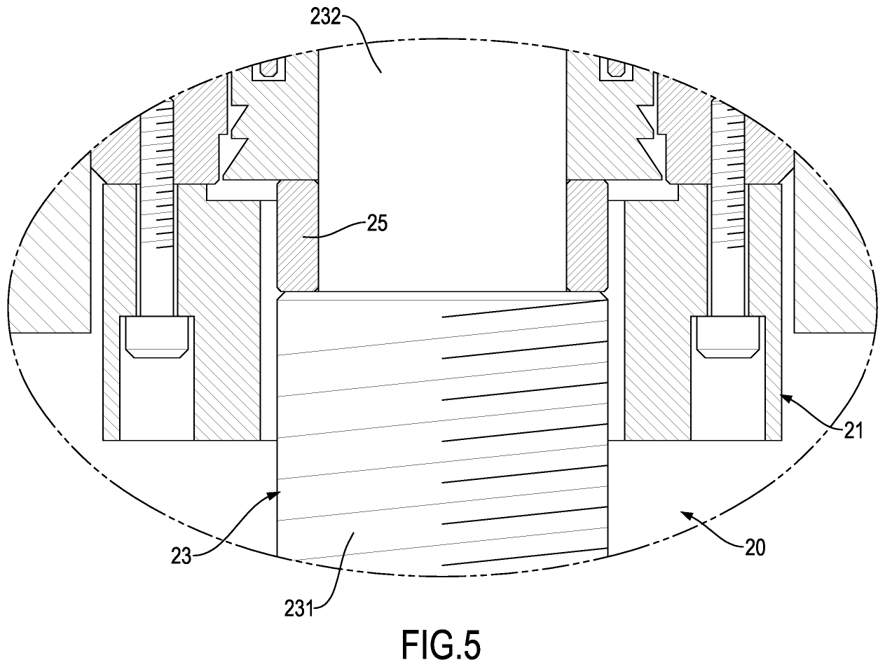

With reference to FIGS. 1, 3A, and 3B, the second holding base 22 is mounted on the saddle base 122 that is adjacent to the workpiece mount 13. The second holding base 22 comprises a base body 221, an oil seal, and four thrust bearings 222. The oil seal and the four thrust bearings 222 are mounted in the base body 221. The four thrust bearings 222 are divided into two bearing groups. The two bearings 222 of each bearing group are arranged in the same direction, but the two bearing groups are arranged in opposite directions. The arrangement of the four thrust bearings can be in a manner as shown in FIG. 3A or FIG. 3B.

With reference to FIGS. 1, 2, 3A, and 3B, the threaded rod 23 is formed as a single part and comprises a driving thread segment 231, a first assembling segment 232, and a second assembling segment 233 co-axially connected with each other. The driving thread segment 231 has a first end and a second end opposite each other. The first assembling segment 232 is formed on and protrudes from the first end of the driving thread segment 231, is mounted through the two thrust bearings 212 in the first holding base 21 to be connected rotatably with the first holding base 21, and has a length. The second assembling segment 233 is formed on and protrudes from the second end of the driving thread segment 231, extends toward the workpiece mount 13, is mounted through the four thrust bearings 222 in the second holding base 22 to be connected rotatably with the second holding base 22, and has a length. The length of the second assembling segment 233 is shorter than that of the first assembling segment 232. The threaded rod 23 is connected with and driven by an electrical driver to rotate.

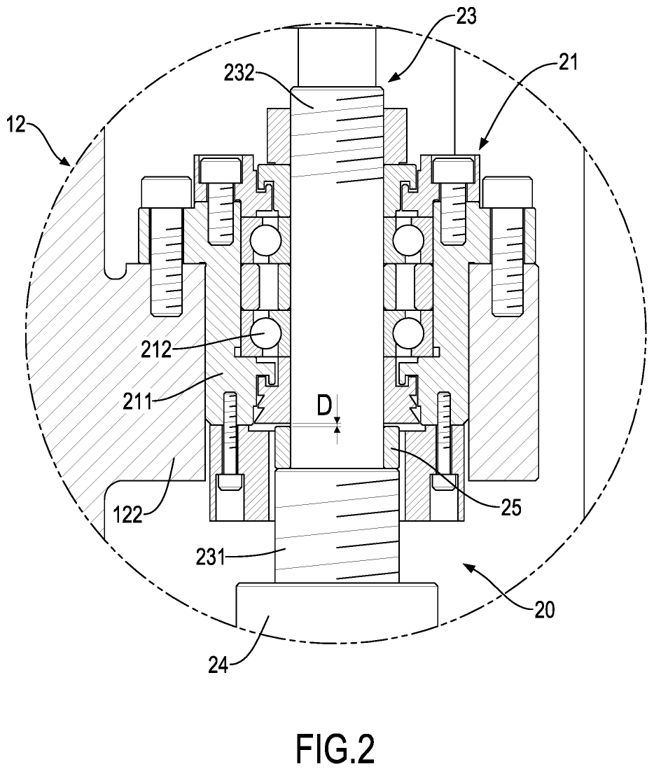

With reference to FIGS. 1 and 2, the moving base 24 is mounted around and screwed with the threaded rod 23. While the threaded rod 23 is driven to rotate, the moving base 24 can be reciprocally moved along the driving thread segment 231. The spacing collar 25 is mounted around the first assembling segment 232. Preferably, because the length of the second assembling segment 233 is shorter than that of the first assembling segment 232, a thermal compensation gap D is formed between the spacing collar 25 and the first holding base 21 with the spacing collar 25 being mounted around the first assembling segment 232.

In practice, by adjusting the length of the base body 211 of the first holding base 21, the number of the thrust bearings 212 in the first holding base 21, or the length of the spacing collar 25, the first end of the driving thread segment 231 can be kept from contact with the first holding base 21. Accordingly, the thermal compensation gap D can be defined between the first end of the driving thread segment 231 and the first holding base 21.

With reference to FIG. 1, the machining assembly 30 comprises an axle head 31, an axle 32, and a tool 33. The axle head 31 of the machining assembly 30 is connected with the moving base 24 and is moved with the moving base 24 reciprocally along the driving thread segment 31. The axle 32 is mounted in the axle head 31. The tool 33 is connected with the axle 32 and is driven to rotate by the axle 32 to process a workpiece.

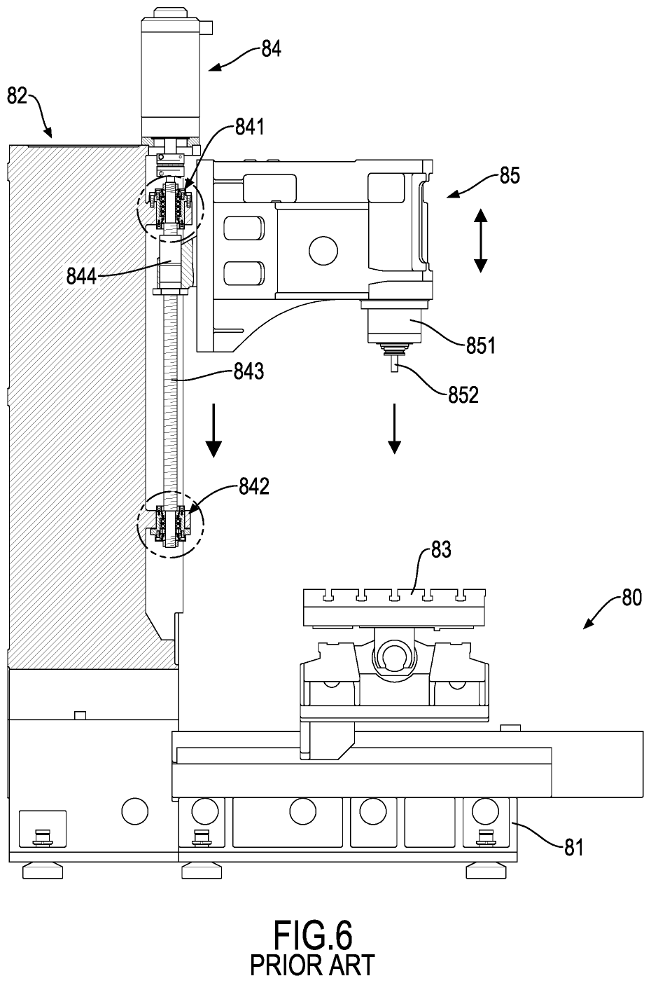

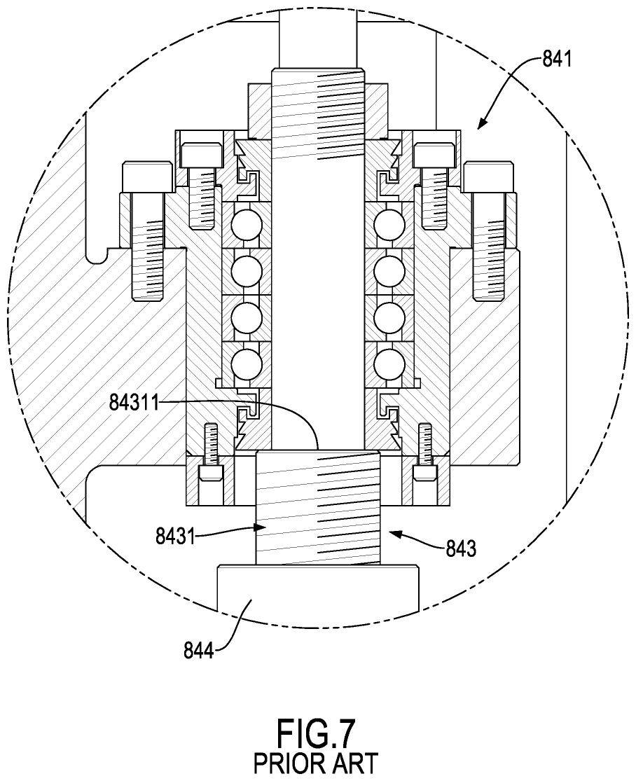

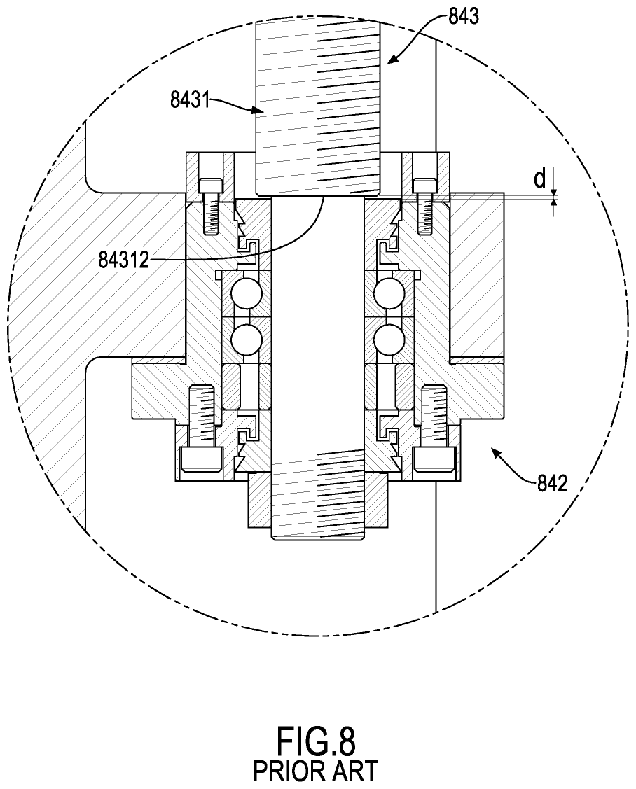

The driving assembly 20 of the machine tool in accordance with the present invention has the thermal compensation gap D formed between the first end of the driving thread segment 231 and the first holding base 21. Therefore, when both the driving assembly 20 and the axle 32 of the machining assembly 30 have thermal expansions, the thermal expansions of the driving assembly 20 and the axle 32 are respectively in opposite directions. Accordingly, the problems caused by the thermal compensation gap d formed between the second end 84312 of the driving thread segment 8431 of the threaded rod 843 and the second holding base 84 of the conventional machine tool 80 as shown in FIGS. 6 to 8 can be effectively solved. The machining accuracy of the machine tool in accordance with the present invention is precise.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A machine tool comprising:
a machine body having a workpiece mount;
a driving assembly having
a first holding base and a second holding base mounted securely on the machine body and spaced from each other;
a threaded rod formed as a single part and comprising
a driving thread segment having a first end and a second end opposite the first end;
a first assembling segment co-axially formed on and protruding from the first end of the driving thread segment and connected rotatably with the first holding base; and
a second assembling segment co-axially formed on and protruding from the second end of the driving thread segment, extending toward the workpiece mount, and connected rotatably with the second holding base;
a moving base mounted around and screwed with the driving thread segment and being reciprocally moveable along the driving thread segment; and
a thermal compensation gap formed between the first end of the driving thread segment and the first holding base; and
a machining assembly mounted securely on the moving base.

2. The machine tool as claimed in claim 1, wherein the second assembling segment has a length shorter than a length of the first assembling segment.

3. The machine tool as claimed in claim 2, wherein
the driving assembly further comprises a spacing collar mounted around the first assembling segment; and
the thermal compensation gap is formed between the spacing collar and the first holding base.

4. The machine tool as claimed in claim 1, wherein
the driving assembly further comprises a spacing collar mounted around the first assembling segment; and
the thermal compensation gap is formed between the spacing collar and the first holding base.
